(19) United States
(12) Patent Application Publication
(10) Pub. No.: US 2007/0239673 A1
(43) Pub. Date: Oct. 11, 2007

(54) REMOVING NODES FROM A QUERY TREE BASED ON A RESULT SET

(76) Inventors: Eric Lawrence Barsness, Pine Island, MN (US); Robert Joseph Bestgen, Rochester, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/278,714

(22) Filed: Apr. 5, 2006

(51) Int. Cl. G06F 17/30

(52) U.S. Cl. 707/3

(57) ABSTRACT

In an embodiment, a query tree is created that represents a query expression, where the query tree includes a union of nodes. Each of the nodes represents a respective partition of a table, and the query expression specifies a key value and the table. A determination is made whether a result set exists that includes the key value, where the result set was previously retrieved from the table. If the determination is true, a decision is made based on the result set whether the key value is stored in the respective partition represented by each of the nodes. The nodes for which the key value is not stored in the respective partition are removed from the query tree to create an optimization tree, and the optimization tree is used to retrieve data from the table. In this way, nodes that are not necessary to be searched may be removed from query trees, in order to increase the performance of the query.

### FIELD

This invention generally relates to computer database management systems and more specifically relates to selectively removing nodes from a query tree based on a result set of a previous query.

### BACKGROUND

Fundamentally, computer systems are used for the storage, manipulation, and analysis of data. One mechanism for managing data is called a database management system (DBMS), which may also be called a database system or simply a database. Many different types of databases are known, but the most common is usually called a relational database (RDB), which organizes data in tables that have rows, which represent individual entries or records in the database, and columns, which define what is stored in each row, entry, or record. Each table has a unique name within the database and each column has a unique name within the particular table. The database also has an index, which is a data structure that informs the database management system of the location of a certain row in a table given an indexed column value, analogous to a book index informing the reader on which page a given word appears.

To be useful, the data stored in databases must be capable of being retrieved in an efficient manner. The most common way to retrieve data from a database is through statements called database queries, which may originate from user interfaces, application programs, or remote systems, such as clients or peers. A query is a search expression evaluated by the database management system to perform a search of a database. Although the query requires the return of a particular data set, answer set, or a result set, the method of query execution is typically not specified by the query. Thus, the database management system receives the query, interprets the query, and determines what internal steps are necessary to satisfy the query. These internal steps may include an identification of the table or tables specified in the query, the row or rows selected in the query, and other information such as whether to use an existing index, whether to build a temporary index, whether to use a temporary file to execute a sort, and/or the order in which the tables are to be unioned together to satisfy the query.

When taken together, these internal steps are referred to as an execution plan. The execution plan is typically created by a component that is often called a query optimizer. The query optimizer may be part of the database management system or separate from, but in communication with, the database management system. When a query optimizer creates an execution plan for a given query, the execution plan is often saved by the database management system in the program object, e.g., the application program, that requested the query. The execution plan may also be saved in an SQL (Structured Query Language) package or an execution plan cache. Then, when the user or program object repeats the query, which is a common occurrence, the database management system can find and reutilize the associated saved execution plan instead of undergoing the expensive and time-consuming process of recreating the execution plan. Thus, reusing execution plans increases the performance of queries when performed by the database management system.

Many different execution plans may be created for any one query, each of which returns the required data set, yet the different execution plans may provide widely different performance. Thus, especially for large databases, the execution plan selected by the database management system needs to provide the required data at a reasonable cost in terms of time and hardware resources. Hence, the query optimizer often creates multiple prospective execution plans and then chooses the best, or least expensive one, to execute.

One factor that contributes to the cost of executing a particular execution plan is the way in which the database table or tables to which the query is directed are partitioned. Partitioning allows for table data to be stored using more than one physical data space, but the table appears as one object for data manipulation operations, such as queries, inserts, updates, and deletes. Partitioning can significantly improve performance if it is done properly, but partitioning also has the potential to decrease performance if done improperly. Partitioning has two fundamental types: horizontal and vertical. Horizontal partitioning allows tables to be partitioned into disjoint sets of rows, which are physically stored and accessed separately in different data spaces. In contrast, vertical partitioning allows a table to be partitioned into disjoint sets of columns, which are physically stored and accessed separately in different data spaces.

In order to execute a query that requires multiple partitions, a union operation is typically performed, which forms the union of multiple partitions. A query is typically represented by a query tree that includes nodes that represent the union operation and the partitions that it unions. One goal of a query optimizer when dealing with partitioned databases is to remove nodes from the query tree, whenever possible, in order to increase performance by eliminating partitions that must be searched in order to perform the query.

Hence, an enhanced technique for eliminating nodes from query trees is needed, in order to increase performance.

### SUMMARY

A method, apparatus, system, and signal-bearing medium are provided. In an embodiment, a query tree is created that represents a query expression, where the query tree includes a union of nodes. Each of the nodes represents a respective partition of a table, and the query expression specifies a key value and the table. A determination is made whether a result set exists that includes the key value, where the result set was previously retrieved from the table. If the determination is true, a decision is made based on the result set whether the key value is stored in the respective partition represented by each of the nodes. The nodes for which the key value is not stored in the respective partition are removed from the query tree to create an optimization tree, and the optimization tree is used to retrieve data from the table. If the determination is false, in various embodiments, the result set may be created or a recommendation may be made to a user to create the result set. In this way, nodes that are not necessary to be searched may be removed from query trees, in order to increase the performance of the query.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2A depicts a block diagram of an example database, according to an embodiment of the invention.

FIG. 2B depicts a block diagram of an example partition view of a table of the database, according to an embodiment of the invention.

FIG. 3A depicts a block diagram of an example query expression, according to an embodiment of the invention.

FIG. 3B depicts a block diagram of an example query tree, according to an embodiment of the invention.

FIG. 4A depicts a block diagram of an example query expression, according to an embodiment of the invention.

FIG. 4B depicts a block diagram of an example materialized query table result set, according to an embodiment of the invention.

FIG. 5 depicts a block diagram of an example optimization tree, according to an embodiment of the invention.

FIG. 6 depicts a flowchart of example processing for a query, according to an embodiment of the invention.

FIG. 7 depicts a flowchart of further example processing for a query, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In various embodiments, a query tree is created that represents a query expression, where the query tree includes a union of nodes. Each of the nodes represents a respective partition of a table, and the query expression specifies a key value and the table. A determination is made whether a result set exists that includes the key value, where the result set was previously retrieved from the table. If the determination is true, a decision is made based on the result set whether the key value is stored in the respective partition represented by each of the nodes. The nodes for which the key value is not stored in the respective partition are removed from the query tree to create an optimization tree, and the optimization tree is used to retrieve data from the table. If the determination is false, in various embodiments, the result set may be created or a recommendation may be made to a user to create the result set. In this way, nodes that are not necessary to be searched may be removed from query trees, in order to increase the performance of the query.

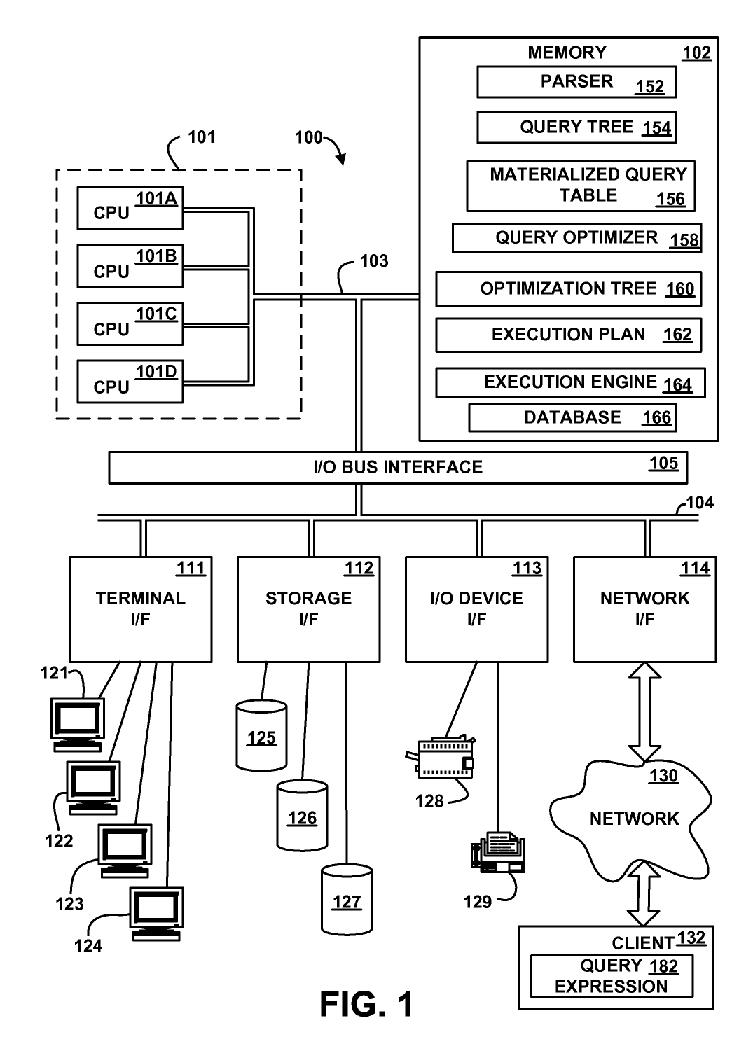

Referring to the Drawings, wherein like numbers denote like parts throughout the several views, FIG. 1 depicts a high-level block diagram representation of a server computer system 100 connected to a client 132 via a network 130, according to an embodiment of the present invention. The terms “client” and “server” are used herein for convenience only, and in various embodiments a computer that operates as a client in one environment may operate as a server in another environment, and vice versa. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes a parser 152, a query tree 154, a materialized query table result set 156, a query optimizer 158, an optimization tree 160, an execution plan 162, an execution engine 162, and a database 166. Although the parser 152, the query tree 154, the materialized query table result set 156, the query optimizer 158, the optimization tree 160, the execution plan 162, the execution engine 162, and the database 166 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the parser 152, the query tree 154, the materialized query table result set 156, the query optimizer 158, the optimization tree 160, the execution plan 162, the execution engine 162, and the database 166 are illustrated as being contained within the main memory 102, these elements are not necessarily all completely contained in the same storage device at the same time. Further, although the parser 152, the query tree 154, the materialized query table result set 156, the query optimizer 158, the optimization tree 160, the execution plan 162, the execution engine 162, and the database 166 are illustrated as being separate entities, in other embodiments some of them, or portions of some of them, may be packaged together.

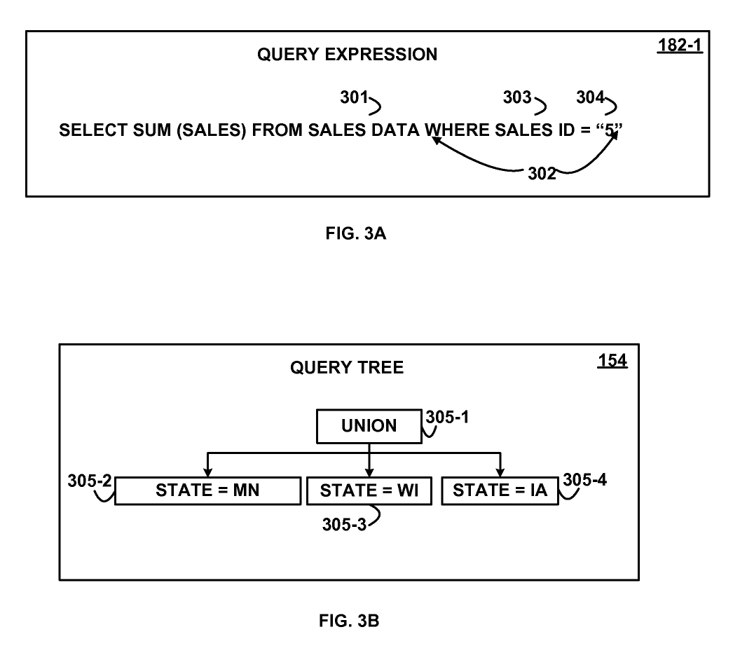

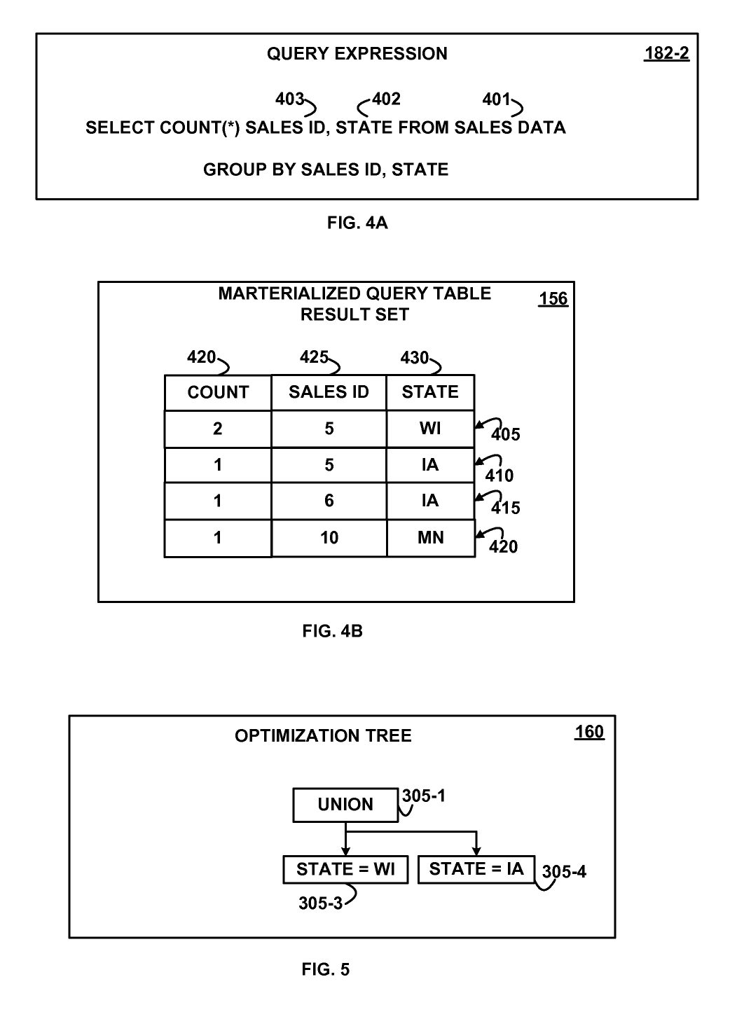

The parser 152 verifies the syntax of a query expression received from the client 132 and parses the received query expression to produce the query tree 154. The query optimizer 158 accepts the query tree 154 and the materialized query table result set 156 as input and, in response, creates the optimization tree 160 and the execution plan 162, which is based on the optimization tree 160. The query optimizer 158 may remove nodes from the query tree 154 based on the materialized query table result set 156 to create the optimization tree 160. The query tree 154 is further described below with reference to FIG. 3B. The materialized query table result set 156 is a cache or buffer that includes an answer set or result set of data (rows and columns) of data retrieved from the database 166 as the result of a previous query expression or expressions. The materialized query table result set 156 is different from the result set requested by the query tree 154. The materialized query table result set 156 is further described below with reference to FIG. 4B. The optimization tree 160 is further described below with reference to FIG. 5.

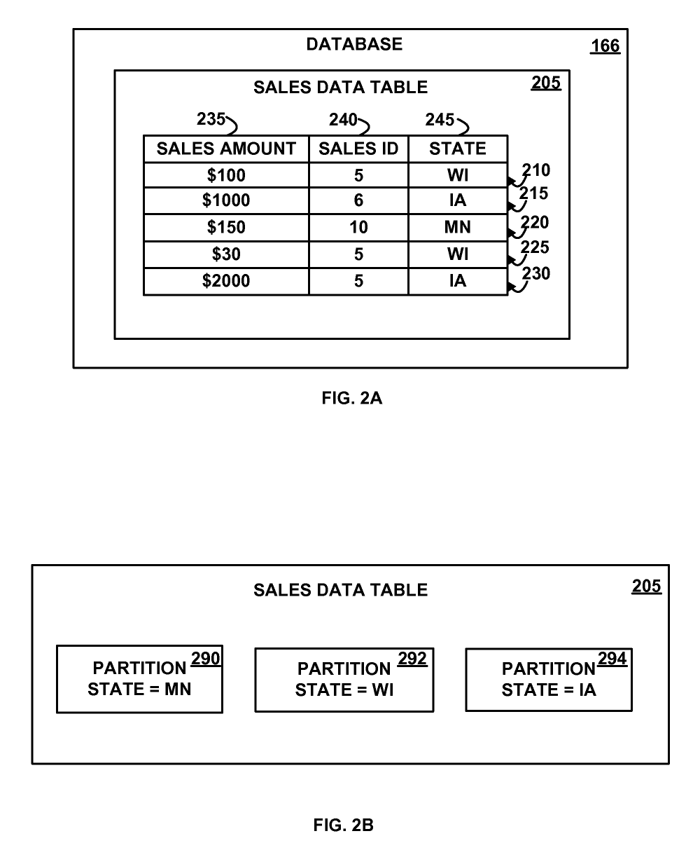

The execution engine 164 executes the query represented by the execution plan 162 against the database 166 to search the database 166 for rows and columns that satisfy the query. The execution plan 162 includes low-level information indicating the steps that the execution engine 164 is to take to execute the query against the database 166. The execution plan 162 may include, in various embodiments, an identification of the table or tables in the database 166 specified in the query expression, the row or rows selected in the query expression, and other information such as whether to use an existing index, whether to build a temporary index, whether to use a temporary file to execute a sort, and/or the order in which the tables are to be unioned together to satisfy the query. The database 166 includes data, e.g., organized in rows and columns, and indexes used to access the data. The database 166 is further described below with reference to FIG. 2A.

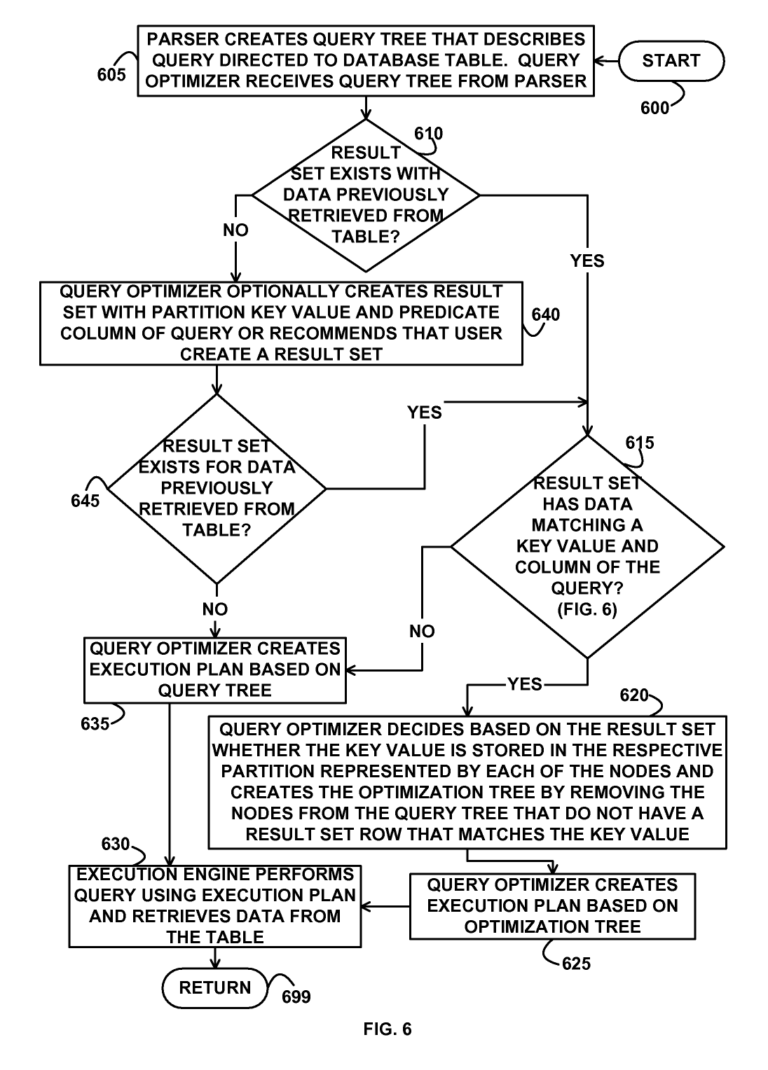

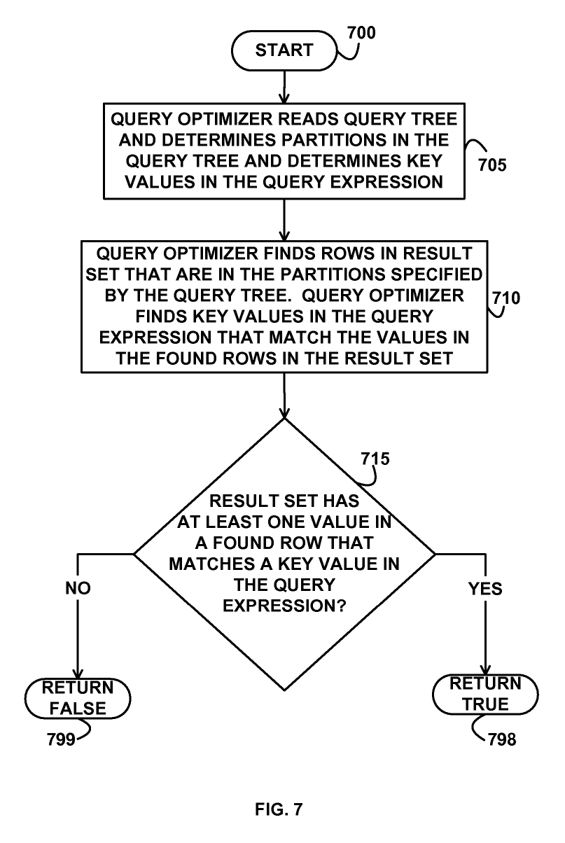

In an embodiment, the query optimizer 158 includes instructions capable of executing on the processor 101 or statements capable of being interpreted by instructions executing on the processor 101 to perform the functions as further described below with reference to FIGS. 6 and 7. In another embodiment, the query optimizer 158 may be implemented in microcode. In another embodiment, the query optimizer 158 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client 132 may include some or all of the hardware and/or software elements previously described above for the computer system 100. The client 132 sends a query expression 182 to the computer system 100 that is directed to the database 166. In an embodiment, a query expression includes a combination of SQL (Structured Query Language) commands intended to produce one or more output data tables or result sets according to a specification included in the query expression 182, but in other embodiments any appropriate query language may be used. Although the client 132 is illustrated as being separate from and connected to the compute system 100 via the network 130, in another embodiment, the client 132 may be part of the computer system 100, e.g., the client 132 may be a software program stored in the memory 102 that executes on the processor 101. The query expression 182 is further described below with reference to FIGS. 3A and 4A.

It should be understood that FIG. 1 is intended to depict the representative major components of the computer system 100, the network 130, and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of an example database 166, which includes an example data table 205, according to an embodiment of the invention. The example data table 205 includes rows 210, 215, 220, 225, and 230, each of which includes example columns 235, 240, and 245. But, in other embodiments any type and number of tables with any appropriate data may be present. The column 235 identifies an amount of sale, the column 240 identifies the sales person who made the corresponding sale, and the column 245 identifies the state in which the sale was made. Thus, the example row 210 represents that a salesperson whose sales identifier 240 is “5” made a sale with an amount 235 of “$100” in the state 245 of “WI” (Wisconsin); the example row 215 represents that a salesperson whose sales identifier 240 is “6” made a sale with an amount 235 of “$1000” in the state 245 of “IA” (Iowa); the example row 220 represents that a salesperson whose sales identifier 240 is “10” made a sale with an amount 235 of “$150” in the state 245 of “MN” (Minnesota); the example row 225 represents that a salesperson whose sales identifier 240 is “5” made a sale with an amount 235 of “$30” in the state 245 of “WI” (Wisconsin); and the example row 230 represents that a salesperson whose sales identifier 240 is “5” made a sale with an amount 235 of “$2000” in the state 245 of “IA” (Iowa).

FIG. 2B depicts a block diagram of an example partition view of the table 205 of the database 166, according to an embodiment of the invention. In an embodiment, the sales data table 205 is divided into multiple partitions 290, 292, and 294, one partition for each key value in the state column 245. Thus, although the sales data table 205 appears in FIG. 2A as if its data is stored together as one table, the sales data table 205 of FIG. 2A is actually a logical view of the database 166, and the various data of the sales data table 205 may actually be physically distributed across a variety of partitions 290, 292, and 294, in a variety of physical storage locations within the computer system 100.

For example, the sales data table 205 may be divided into the partition 290 that includes the row 220 (the partition 290 includes all rows with a state 245 of “MN”), the partition 292 that includes rows 210 and 225 (the partition 292 includes all rows with a state 245 of “WI”), and the partition 294 that includes the rows 215 and 230 (the partition 294 includes all rows with a state 245 of “IA”). Thus, the multiple partitions 290, 292, and 294 for sales data table 205 are, in this example, horizontal partitions containing rows that represents sales made in MN, WI, and WI. But, in other embodiments any type and number of partitions with any appropriate data and any appropriate type of operation may be present. For example, in other embodiments, the data table 205 may be divided into vertical partitions, in which the table 205 is divided into disjoint sets of the columns 235, 240, and/or 245. Further, the values any of the rows or columns may be used to partition the data table 205.

FIG. 3A depicts a block diagram of an example query expression 182-1, according to an embodiment of the invention. The query expression 182-1 is an example of the query expression 182 (FIG. 1). The example query expression 182-1 is illustrated using the syntax of SQL (Sequential Query Language), but in other embodiments any appropriate syntax may be used.

The query expression 182-1 requests the retrieval of those rows selected from the table 301 of the database 166 that meet the specified condition 302. The condition 302 specifics the condition or criteria that the rows must satisfy in order to be selected. For example, the condition 302 in the query expression 182-1 specifies that the rows must include a column 303 (e.g., the sales identifier column 240 of FIG. 2A) with a specified key value 304 (e.g., “5”) in order to be selected.

Thus, the example query expression 182-1 requests that all of the rows from the sales data table 205 that have a sales identifier 240 key value of “5” be retrieved and the sum of the key values of the sales amount column 235 for those retrieved rows be calculated. Stated another way, the example query expression 182-1 requests the total sales amount for all sales that the salesperson with a sales identifier 240 of “5” has made.

FIG. 3B depicts a block diagram of an example query tree 154, which represents the example query expression 182-1 (FIG. 3A), according to an embodiment of the invention. The parser 152 creates the query tree 154 based on the query expression 182-1. The parser 152 cannot determine (based on the example query expression 182-1 alone) the states 245 in which the salesperson with a sales identifier 240 of “5” has made sales, so the parser 152 creates the query tree 154 to represent a search of all of the partitions of the sales data table 205. Thus, in this example, the query tree 154 represents a union operation of all three of the partitions 290, 292, and 294 of the sales data table 205 (FIG. 2B).

The query tree 154 includes example nodes 305-1, 305-2, 305-3, and 305-4. The node 305-1 represents a union operation of the nodes 305-2, 305-3, and 305-4, which each represent a respective partition of the table 205. In response to the query expression that potentially requests data from multiple partitions or tables, a union operation is performed on the multiple partitions or tables, in order to find and retrieve the data from the multiple partitions or tables. The node 305-2 represents the partition 290 (FIG. 2B) of the sales data table 205 that includes rows that have a key value in the column 245 of “MN.” The node 305-3 represents the partition 292 of the sales data table 205 that includes rows that have a key value in the column 245 of “WI.” The node 305-3 represents the partition 294 of the sales data table 205 that includes rows that have a key value in the column 245 of “IA.”

FIG. 4A depicts a block diagram of an example query expression 182-2, according to an embodiment of the invention. The query expression 182-2 is an example of the query expression 182 (FIG. 1). The example query expression 182-2 is illustrated using the syntax of SQL (Sequential Query Language), but in other embodiments any appropriate syntax may be used. The example query expression 182-2 requests a retrieval of data from the table 401 (the sales data table 205) and requests a count of the rows in the table 401 for each combination of the columns 402 (the sales identifier 240) and 403 (the state 245). Thus, the example query expression 182-2 requests a count of the number of sales for each sales person by the state in which the sales occurred. The result set or answer set for the example query expression 182-2 is illustrated in the materialized query table result set 156, as further described below with reference to FIG. 4B.

FIG. 4B depicts a block diagram of an example materialized query table result set 156, according to an embodiment of the invention. The materialized query table 156 represents an answer set or result set received as a result of the query expression 182-2, which the execution engine 162 previously executed against the sales data table 205.

The example materialized query table result set 156 includes rows 405, 410, 415, and 420, each of which includes columns 420, 425, and 430. The rows 405, 410, 415, and 420 represent rows, a portion or rows, and/or information calculated from rows of the sales data table 205, or any portion or combination thereof that result from a previous query expression. The columns in the materialized query table result set 156 represent columns, a portion of columns, information calculated from columns of the sales data table 205, or any combination or portion thereof that result from a previous query expression. For example, the columns 425 and 430 in the materialized query table result set 156 represent the columns 240 and 245, respectively, in the sales data table 205, as specified by the column 403 and 402, respectively, in the query expression 182-2.

The count 420 indicates the number of times that the combination of the key values in the columns 425 and 430 indicated in their respective rows were present in the data table 205. For example, the count 420 of “2” in the row 405 indicates that the combination of the sales identifier 425 of “5” and the state 430 of “WI” is present twice in the table 205 (in the row 210 and the row 225); the count 420 of “1” in the row 410 indicates that the combination of the sales identifier 425 of “5” and the state 430 of “IA” is present once in the table 205 (in the row 230); the count 420 of “1” in the row 415 indicates that the combination of the sales identifier 425 of “6” and the state 430 of “IA” is present once in the table 205 (in the row 215); the count 420 of “1” in the row 420 indicates that the combination of the sales identifier 425 of “10” and the state 430 of “MN” is present once in the table 205 (in the row 220).

FIG. 5 depicts a block diagram of an example optimization tree 160, according to an embodiment of the invention. The optimization tree 160 represents the same example query expression 182-1 of FIG. 3A as does the query tree 154 of FIG. 3B, but the query optimizer 158 has optimized the optimization tree 160 based on the materialized query table result set 156 (created from the previous query expression 182-2), as further described below.

The optimization tree 160 includes the nodes 305-1, 305-3, and 305-4, but the optimization tree 160 does not include the node 305-2 (FIG. 3B), which the query optimizer 158 removed from the query tree 154 in order to create the optimization tree 160. The query optimizer 158 removed the node 305-2 (representing the partition 290 of the state =“MN”) because the materialized query table result set 156 has data (the row 405 and 410) applicable to the key value (“5”) and column (the sales id column 425) to which the query expression 182-1 is directed, but the partition represented by the node 305-2 does not have an associated row in the result set 156, i.e., the materialized query table result set 156 does not have a row with a sales id 425 of “5” and a state of “MN,” as further described below with reference to FIGS. 6 and 7.

Thus, the execution engine 164 can execute the query expression 182-1 represented by the optimization tree 160 without searching the partition 290 (represented by the deleted node 305-2, which is present in FIG. 3B). Any execution plan based on the query tree 154 (FIG. 3B) causes the execution engine 164 to search the union of the partitions represented by the nodes 305-2, 305-3, and 305-4. But, the example query expression 182-1 requests rows with a sales identifier of “5” and, as can be seen from FIG. 2A, the partition 290 represented by the node 305-2 (FIG. 3B) does not include any rows with a sales identifier of “5” (as shown in FIG. 2A, the salesperson “5” did not make any sales in the state 245 of “MN”). Thus, searching the partition 290 represented by the node 305-2 (state 245=“MN”) serves no useful purpose because it does not yield any relevant results for the example query expression 182-1. Hence, the query optimizer 158 determines, based on the materialized query table result set 156 that the salesperson “5” did not make any sales in the state 245 of “MN,” and so removes the node 305-2 (FIG. 3B) from the query tree 154, yielding the optimization tree 160, which the execution engine 164 uses to perform the query expression 182-1 (to retrieve the relevant rows and columns by searching the partitions 292 and 294 but not the partition 290) against the database 166, as further described below with reference to FIGS. 6 and 7.

FIG. 6 depicts a flowchart of example processing for a query, according to an embodiment of the invention. Control begins at block 600. Control then continues to block 605 where the parser 152 receives the query expression 182 from the client 132 (directly or indirectly) and creates the query tree 154 that describes or represents the query expression that is directed to or requests data returned from the table 205 of the database 166. For example, the query tree 154 illustrated in FIG. 3B describes the query expression 182-1 (FIG. 3A). The query optimizer 158 receives the query tree 154 from the parser 152.

Control then continues to block 610 where the query optimizer 158 determines whether a materialized query table result set 156 exists for the table or tables specified in the query tree 154 by determining whether a materialized query table result set 156 exists that includes rows with data that originated from or were previously retrieved from a table 205 that is the same as a table specified in the query tree 154.

For example, the materialized query table result set 156 illustrated in FIG. 4B includes rows 405, 410, 415, and 420 with columns 425 and 430 that were retrieved from corresponding respective rows 210, 215, 220, 225, and 230 and columns 240 and 245 in the sales data table 205, and the query tree 154 includes nodes 305-2, 305-3, and 305-4 that represent the respective partitions 290, 292, and 294 of the sales data table 205. The materialized query table result set 156 was previously retrieved in that its result set was retrieved in response to the query expression 182-2 (FIG. 4A) that was processed previously to the query expression 182-1, for which the query tree 154 was created at block 605.

If the determination at block 610 is true (as in the example of FIGS. 3B and 4B), then a materialized query table result set 156 exists for the table or tables in the query tree 154, so control continues to block 615 where the query optimizer 158 determines whether the found materialized query table result set 156 includes any data that matches the key values specified by the query expression 182, as further described below with reference to FIG. 6.

If the determination at block 615 is true, then the materialized query table result set 156 has data that matches a column and key value specified by the query expression 182 and the materialized query table result set 156 is a superset of the result set requested by the query tree 154, so control continues to block 620 where the query optimizer 158 creates the optimization tree 160 by removing nodes that do not have associated rows in the materialized query table result set 156 from the query tree 154. The query optimizer 158 decides whether the key value and a partition key value that represents the respective partition are both in a same row of the result set and removes those nodes for which the key value is not stored in the respective partition from the query tree 154 to create the optimization tree 160. For example, query optimizer 158 decides that the key value “5” and a partition key value “MN” that represents the respective partition 290 are not both in a same row of the result set 156 (no row contains both the key value “5” in the sales identifier column 425 and the partition key value “MN” in the state column 430), so the query optimizer 158 removes the corresponding node 305-2 (representing the partition 290) from the query tree 154 to create the optimization tree 160.

Control then continues to block 625 where the query optimizer 158 creates the execution plan 162 based on the optimization tree 160. Control then continues to block 630 where the execution engine 164 performs the query expression against the database 166 using execution plan 162. For example, the execution engine 164 searches the partitions represented by the nodes of the optimization tree 160 for the corresponding key value and retrieves the rows from the database 166 that have data matching the key value. Control then continues to block 699 where the logic of FIG. 6 returns.

If the determination at block 615 is false, then the materialized query table result set 156 does not have data matching the column and key value to which the query expression is directed, so control continues to block 635 where the query optimizer 158 creates the execution plan 162 based on the query tree 154. Control then continues to block 630, as previously described above.

If the determination at block 610 is false, then a materialized query table result set 156 does not exist for the table or tables in the query tree 154, so control continues to block 640 where the query optimizer 158 optionally creates a materialized query table result set 156 with the partition key and columns of the query expression or recommends that the user create a materialized query table result set 156.

Control then continues to block 645 where the query optimizer 158 determines whether a materialized query table result set 156 exists for the tables in tree 154. If the determination at block 645 is true, then a materialized query table result set 156 exists for tables in the query tree 154, so control continues to block 615, as previously described above.

If the determination at block 645 is false, then a materialized query table result set 156 does not exist for tables in the query tree 154, so control continues to block 635, as previously described above.

FIG. 7 depicts a flowchart of further example processing for a query, according to an embodiment of the invention. Control begins at block 700. Control then continues to block 705 where the query optimizer 158 reads the query tree 154 and determines the partitions in the query tree 154 and the key values in the query expression.

Control then continues to block 710 where the query optimizer 158 finds rows in the materialized query table result set 156 that are in the partitions specified by the query tree. The query optimizer further finds key values in the query expression that match the values in the found rows in the result set. Control then continues to block 715 where the query optimizer 158 determines whether the result set has at least one value in a found row that matches a key value in the query expression.

If the determination at block 715 is true, then the materialized query table result set 156 has at least one value in a found row that matches a key value in he query expression, so control continues to block 798 where the logic of FIG. 7 returns true, indicating that the materialized query table result set 156 has data applicable to columns in the database tables to which a key value in a column specified by the query expression is directed.

If the determination at block 715 is false, then the materialized query table result set 156 does not have a key value for partitions in the query tree 154, so control continues to block 798 where the logic of FIG. 7 returns false, indicating that the materialized query table result set 156 does not have data applicable to columns in the database tables to which the query expression is directed.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
creating a query tree that represents a first query expression, wherein the query tree comprises a union of a plurality of nodes, wherein each of the nodes represents a respective partition of a table, and wherein the first query expression specifies a key value;
determining whether a result set exists that comprises the key value, wherein the result set was previously retrieved from the table; and
if the determining is true, deciding based on the result set whether the key value is stored in the respective partition represented by each of the plurality of nodes.

2. The method of claim 1 further comprising:
removing the nodes for which the key value is not stored in the respective partition from the query tree to create an optimization tree; and
retrieving data from the table via the optimization tree.

3. The method of claim 2, wherein the retrieving further comprises:
creating an execution plan based on the optimization tree.

4. The method of claim 3, wherein the retrieving further comprises:
searching the partitions represented by the nodes of the optimization tree for the key value via the execution plan.

5. The method of claim 1, wherein the deciding further comprises:
deciding whether the key value and a partition key value that represents the respective partition are both in a same row of the result set.

6. The method of claim 1, wherein the result set was previously retrieved in response to a second query expression, wherein the second query expression was processed prior to the first query expression.

7. The method of claim 1, further comprising:
if the determining is false, creating the result set.

8. The method of claim 1, further comprising:
if the determining is false, recommending that a user create the result set.

9. A signal-bearing medium encoded with instructions, wherein the instructions when executed comprise:
creating a query tree that represents a first query expression, wherein the query tree comprises a union of a plurality of nodes, wherein each of the nodes represents a respective partition of a table, and wherein the first query expression specifies a key value and the table;
determining whether a result set exists that comprises the key value, wherein the result set was previously retrieved from the table;
if the determining is true, deciding based on the result set whether the key value is stored in the respective partition represented by each of the plurality of nodes;
removing the nodes for which the key value is not stored in the respective partition from the query tree to create an optimization tree; and
retrieving data from the table via the optimization tree.

10. The signal-bearing medium of claim 9, wherein the retrieving further comprises:
creating an execution plan based on the optimization tree.

11. The signal-bearing medium of claim 10, wherein the retrieving further comprises:
searching the partitions represented by the nodes of the optimization tree for the corresponding key value via the execution plan.

12. The signal-bearing medium of claim 9, wherein the deciding further comprises:
deciding whether the key value and a partition key value that represents the respective partition are both in a same row of the result set.

13. The signal-bearing medium of claim 9, wherein the result set was previously retrieved in response to a second query expression, wherein the second query expression was processed prior to the first query expression.

14. The signal-bearing medium of claim 9, further comprising:
if the determining is false, creating the result set.

15. The signal-bearing medium of claim 9, further comprising:
if the determining is false, recommending that a user create the result set.

16. A method for configuring a computer, comprising:
configuring the computer to create a query tree that represents a first query expression, wherein the query tree comprises a union of a plurality of nodes, wherein each of the nodes represents a respective partition of a table, and wherein the first query expression specifies a key value and the table;
configuring the computer to determine whether a result set exists that comprises the key value, wherein the result set was previously retrieved from the table;
configuring the computer to, if the determining is true, decide based on the result set whether the key value is stored in the respective partition represented by each of the plurality of nodes;
configuring the computer to remove the nodes for which the key value is not stored in the respective partition from the query tree to create an optimization tree; and
configuring the computer to retrieve data from the table via the optimization tree.

17. The method of claim 16, wherein the configuring the computer to retrieve further comprises:
configuring the computer to create an execution plan based on the optimization tree.

18. The method of claim 17, wherein the configuring the computer to retrieve further comprises:
configuring the computer to search the partitions represented by the nodes of the optimization tree for the key value via the execution plan.

19. The method of claim 16, wherein the configuring the computer to decide further comprises:
configuring the computer to decide whether the key value and a partition key value that represents the respective partition are both in a same row of the result set.

20. The method of claim 16, wherein the result set was previously retrieved in response to a second query expression, wherein the second query expression was processed prior to the first query expression.
